(19) United States
(12) Patent Application Publication
(10) Pub. No.: US 2007/0211813 A1
(43) Pub. Date: Sep. 13, 2007

(54) MIMO precoding in the presence of co-channel interference

(76) Inventors: Shilpa Talwar, Santa Clara, CA (US); Roopsha Samanta, Austin, TX (US); Nageen Himayat, Fremont, CA (US)

Correspondence Address: INTEL CORPORATION;c/o INTELLEVATE, LLC, P.O. BOX 52050, MINNEAPOLIS, MN, 55402, US

(21) Appl. No.: 11/373,654

(22) Filed: Mar. 10, 2006

(51) Int. Cl. H04L 1/02

(52) U.S. Cl. 375/267

(57) ABSTRACT

Methods and systems for communicating in a wireless network include mitigating co-channel interference (CCI) for precoded multiple-input multiple-output (MIMO) systems and incorporating the effect of CCI mitigation on channel characteristics in the design of channel state information (CSI) feedback mechanisms. Various embodiments and variants are also disclosed.

### BACKGROUND OF THE INVENTION

It is becoming increasingly popular to use multi-antenna systems in wireless communication networks to obtain advantages of increased channel capacity and/or link reliability. Such multi-antenna systems are generically referred to herein as multiple-input multiple-output (MIMO) systems but which may also include multiple-input single output (MISO) and/or single-input multiple-output (SIMO) configurations.

MIMO systems promise high spectral efficiency and have been recently proposed in many emerging wireless communication standards. There has been a significant amount of work recently on precoding for spatially multiplexed or space-time coded MIMO systems. Precoding is a technique used to provide increased array and/or diversity gains. In an example of a closed-loop orthogonal frequency division multiplexing (OFDM) system, channel state information (CSI) may be fed back to a transmitter and used to form precoding matrices for OFDM subcarriers to be transmitted. To date, most precoding research has primarily concentrated on single-user systems. However, in a multi-user environment, such as cellular networks and the like, co-channel interference (CCI) from neighboring equipment using similar frequency resources may be present and have an impact on a channel between two communicating devices. It would be desirable for a closed-loop MIMO system to mitigate CCI and use a precoding scheme which takes into account the effective channel after CCI mitigation.

### BRIEF DESCRIPTION OF THE DRAWING

Aspects, features and advantages of the present invention will become apparent from the following description of the invention in reference to the appended drawing in which like numerals denote like elements and in which:

FIG. 1 is block diagram of a wireless network according to one embodiment of the present invention;

FIG. 2 is a flow diagram showing a general method for precoding OFDM signals using closed-loop feedback of the effective channel after CCI mitigation; and

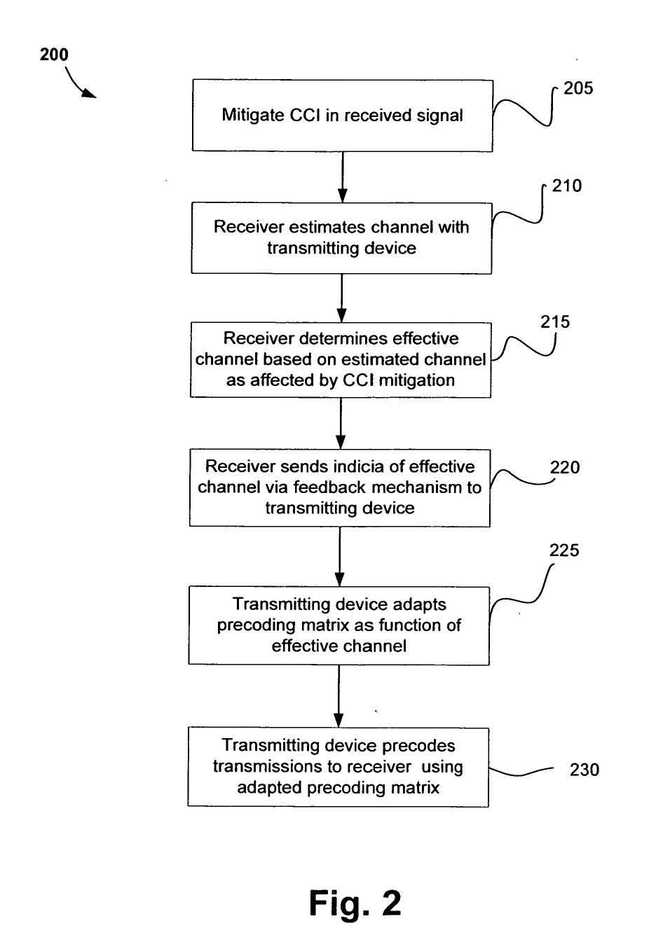

FIG. 3 is a functional block diagram of an example embodiment for apparatuses adapted to perform one or more of the methods of the present invention.

### DETAILED DESCRIPTION OF THE INVENTION.

While the following detailed description may describe example embodiments of the present invention in relation to wireless networks utilizing OFDM or Orthogonal Frequency Division Multiple Access (OFDMA) modulation, the embodiments of present invention are not limited thereto and, for example, can be implemented using other modulation and/or coding schemes such as code division multiple access (CDMA) or single carrier systems where the principles of the inventive embodiments may be suitably applicable. Further, while example embodiments are described herein in relation to broadband wireless metropolitan area networks (WMANs), the invention is not limited thereto and can be applied to other types of wireless networks where similar advantages may be obtained. Such networks specifically include, but are not limited to, wireless local area networks (WLANs), wireless personal area networks (WPANs) and/or wireless wide area networks (WWANs) such as cellular networks.

The following inventive embodiments may be used in a variety of applications including transmitters of a radio system and transmitters of a wireless system, although the present invention is not limited in this respect. Radio systems specifically included within the scope of the present invention include, but are not limited to, network interface cards (NICs), network adaptors, mobile stations, base stations, access points (APs), hybrid coordinators (HCs), gateways, bridges, hubs and cellular radiotelephones. Further, the radio systems within the scope of the invention may include satellite systems, personal communication systems (PCS), two-way radio systems, two-way pagers, personal computers (PCs) and related peripherals, personal digital assistants (PDAs), personal computing accessories and all existing and future arising systems which may be related in nature and to which the principles of the inventive embodiments could be suitably applied.

Embodiments of the present invention may provide a method/apparatus for modifying precoding schemes of multi-antenna systems to make them more robust in the presence of CCI. As mentioned previously, precoding requires knowledge of channel state information (CSI) at the transmitter. There are various ways for a transmitter to realize CSI depending on the system involved.

For example, in a single user time division duplexing (TDD) system, CSI can be determined based on the inherent reciprocal characteristics of the channel. However, in interference-limited scenarios, with multiple base stations and/or subscriber stations transmitting on the same time-frequency resource, channel reciprocity is not a reliable indicator as the interference in the uplink and downlink may generally not be symmetric. In these cases, it is necessary to use a feedback link to convey CSI and/or interference state information (ISI) from a receiving device to the transmitter (as used hereafter CSI in generically used to mean information about the channel state and/or ISI information). Similarly, a frequency division duplex (FDD) system inherently requires a feedback path for informing the transmitter about the channel and interference. Accordingly, embodiments of the present invention may modify existing feedback mechanisms, often referred to as “closed-loop” systems, for conveying CSI to the transmitter regarding the effective channel obtained after CCI mitigation.

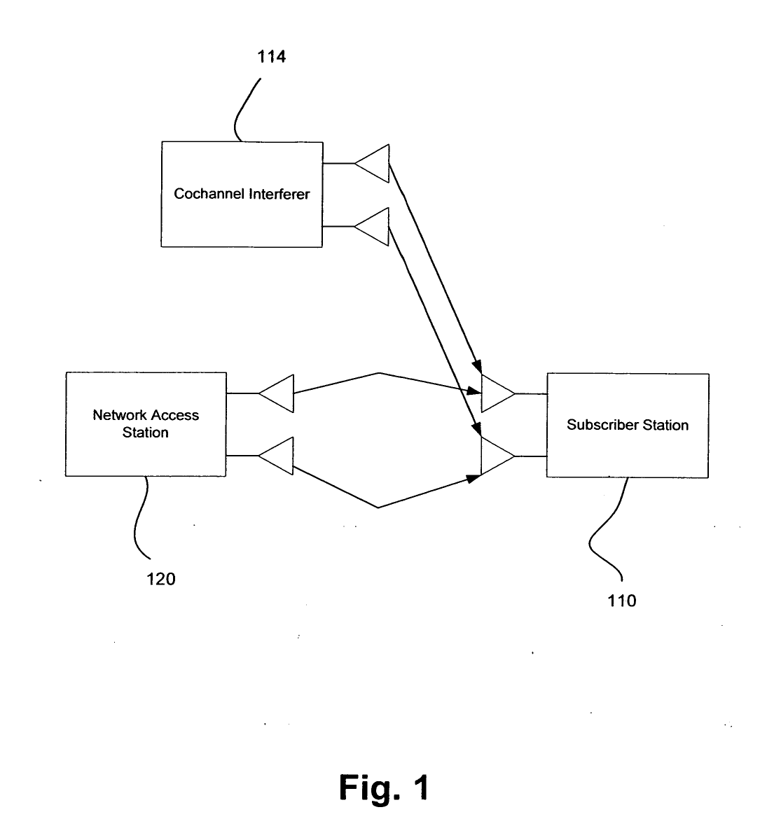

Turning to FIG. 1, a wireless communication system 100 according to one embodiment of the invention may include one or more subscriber stations 110 (alternatively referred to as user stations) and one or more network access stations 120 (alternatively referred to as base stations). System 100 may be any type of wireless network such as a wireless metropolitan area network (WMAN), wireless wide area network (WWAN) or wireless local area network (WLAN) where subscriber stations 110 communicate with network access stations 120 via an air interface.

System 100 may further include one or more other wired or additional wireless network devices as desired. In certain embodiments system 100 may communicate via an air interface utilizing multi-carrier modulation such as OFDM and/or orthogonal frequency division multiple access (OFDMA), although the embodiments of the invention are not limited in this respect. OFDM works by dividing up a wideband channel into a larger number of narrowband subcarriers or sub-channels, where a subchannel denotes one or more subcarriers. Each subcarrier or subchannel may be modulated separately depending on the signal interference to noise ratio (SINR) characteristics in that particular narrow portion of the band. In operation, transmission may occur over a radio channel which, in some networks, may be divided into intervals of uniform duration called frames composed of a plurality of OFDM and/or OFDMA symbols, each of which may be composed of several subcarriers. There are many different physical layer protocols which may be used to encode data on subcarriers and a channel may carry multiple service flows of data between base station 120 and user stations 110.

FIG. 1 represents an illustrative example of the CCI which may occur between multi-antenna devices (e.g., user stations and/or base stations) operating in network 100. For simplicity signals emanating from and/or received by the antennas of respective devices 110, 114 and 120 are illustrated as lines in a direction corresponding to the associated arrows. In reality of course these signals are likely omnidirectional in nature rather than directional and FIG. 1 is presented in a very simplified manner for improved understanding. In the scenario of FIG. 1, base station 120 is transmitting to subscriber station 110. However, the antennas on receiving device 110 may not only receiving the signals from base station 120, but also receiving signals from one or more neighboring stations or devices (designated as co-channel interferer 114).

Because signals from interferer 114 are not intended for or address to subscriber station 110, they may appear as noise spatially correlated across the antennas of station 110. Noise which is correlated across two or more antennas of a device is referred to herein as “colored noise” and designated as N_{colored}. By contrast, random noise (e.g., thermal noise) not correlated across antennas is referred to as “white noise” and is designated as N_{white}.

In various embodiments, subscriber station 110 may include circuitry/logic to mitigate (e.g., by filter or other method) detected noise in order to maintain a desirable SINR or signal-to-noise ratio (SNR). Subscriber station 110 may also include circuitry/logic to estimate the characteristics of the communication channel at a particular instance in time so that the channel characteristics may be fed back to the transmitting device to, in one example, determine how subcarriers should be modulated in future transmissions to the receiver.

In one example, we consider the case of a transmission (Y) for a single user precoded MIMO-OFDM system represented by equation (1) below:
Y=HFX+N_{white} (1);

where the precoding matrix F is a function of the channel matrix H and X represents the data signal. In the presence of multi-user/co-channel interference, the system can modeled as the single-user MIMO-OFDM system of equation (1) with the addition of colored noise as shown below in equation (2):
Y=HFX+H_{cci}X_{cci}+N_{white}→+Y=HFX+N_{colored} (2).

In this case a simple equalization or CCI mitigation technique that might be used by the receiver would be to apply a whitening filter (W) to the signal as shown by the example equation (3) below:
WY=WHFX+WN_{colored}→WY=H_{eff}FX+N_{white} (3).

A convenient choice for a whitening filter in one embodiment is W_{colored}^{-1/2} where R_{colored} is the noise covariance matrix and the square root denotes the Cholesky decomposition. The Cholesky decomposition, named after André-Louis Cholesky, is a matrix decomposition of a symmetric positive-definite matrix into a lower triangular matrix and the transpose of the lower triangular matrix.

As shown by the right portion of equation (3), this may reduce to the problem of equation (1) but with a new effective channel H_{eff}. However, if the precoding matrix F is chosen as a function of the original channel H as is conventionally done, then the desired preceding gain may be lost. By way of example, assume precoding matrix F is chosen such that F=V, where V corresponds to the right singular vectors of the channel matrix H=UΣV* and U is the left orthogonal matrix. F is typically selected to be F=V to enable diagonalization of the channel and therefore simplify receive processing. However using F=V equation (3) may be rewritten as follows:
WY=WUΣX+N_{white} (4).

From equation (4) it evident that the presence of whitening filter W complicates the receive processing and prevents the channel from being diagonalized. In order to overcome this issue in various inventive embodiments, the precoder in the transmitter may be designed to use precoding matrices which are a function of the effective channel H_{eff} (i.e., the channel H as impacted by CCI mitigation). For example if F=V_{eff} where the singular value decomposition of the effective channel is H_{eff}=U_{eff}Σ_{eff}V_{eff}*, equation (3) can be simplified as:
WY=U_{eff}Σ_{eff}X+N_{white} (5).

Decoding can thus be completed simply by pre-multiplying the whitened data vector WY with U_{eff}* to diagonalize the channel. Based on the foregoing scheme, it is necessary to take into account the CCI mitigation algorithm in the design of the precoder so the preceding matrix may be selected as a function of the effective channel H_{eff}. This requires modifications to conventional feedback schemes as explained below.

The linear transformation of original channel H to effective channel H_{eff} can result in a new channel distribution. It has been shown, for instance, that if the channel H was an uncorrelated Rayleigh fading channel, then H_{eff} would no longer be uncorrelated. Because the use of feedback schemes specifically designed for uncorrelated channels are known to lose performance in correlated channels, the adaptation of existing feedback schemes to feedback indicia of the effective channel after CCI mitigation will depend on practical factors such as the original channel distribution, the CCI mitigation algorithm used, and/or the type of interference knowledge that may be obtained at the receiver as explored in the various embodiments below.

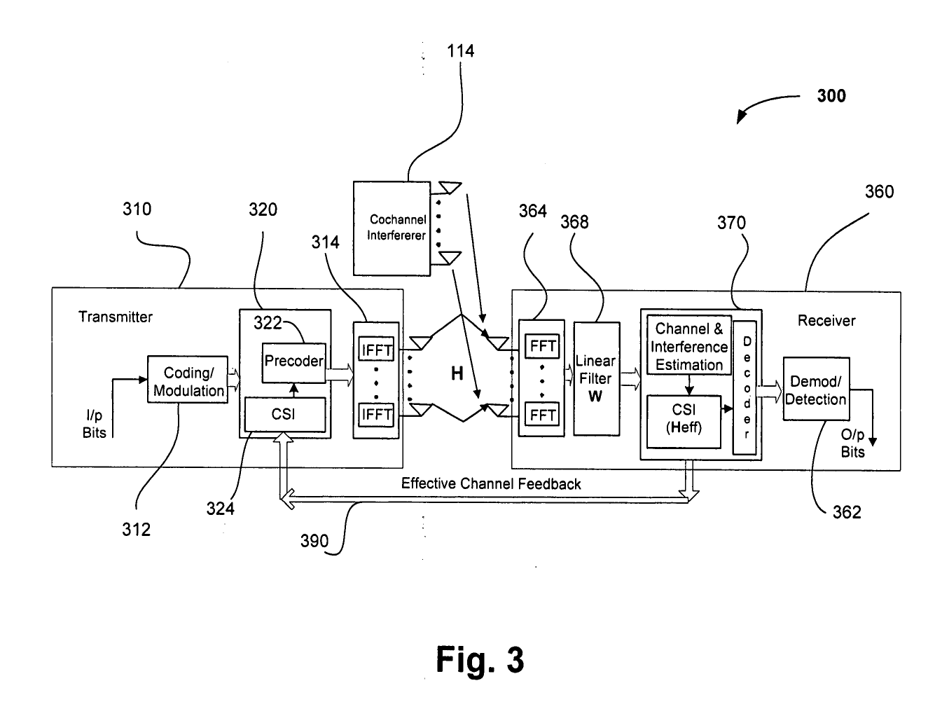

Turning to FIG. 3 a method 300 of precoding transmissions as a function of the effective channel after CCI mitigation may generally include a receiver: mitigating 305 CCI of a received signal, determining 315 the effective channel between the receiver and the transmitting device and feeding back 320 channel state information (CSI) regarding the effective channel after CCI mitigation to the transmitter. Based on this feedback, the transmitting device may then select or adapt 325 a precoding matrix that is a function of the effective channel and use it to precode 330 transmissions.

As mentioned previously, a basic technique for mitigating 305 the CCI in a received signal is to use a linear whitening filter to filter the colored noise from the received signal. However, there may be various other techniques for mitigating/suppressing/filtering CCI and the inventive embodiments may be equally suitable for other mitigation techniques. Estimating 310 the channel H may be performed in any conventional manner to obtain a model of the communication channel. The effective channel H_{eff} and/or its singular value components (e.g., V*_{eff}) may be determined 315 depending on the specific CCI mitigation algorithm used and its impact on the estimated channel H. In the forgoing example using the basic linear whitening filter W, the effective channel may simply be H_{eff}=WH.

Feedback 320 of the effective channel state information (ECSI) will depend on the type of feedback-based precoding scheme to which the inventive embodiments might be applied. Three example current schemes and their potential application with the inventive embodiments are as follows:

1. Partial CSI Feedback Based on Channel Statistics:

MIMO beamforming systems based on first and second order channel statistics, which rely on the feedback of the channel mean or covariance matrices have been proposed. These schemes have a loss in performance as compared to optimal eigenbeamforming techniques but may have reduced feedback requirements. They can readily be extended to use the whitening approach previously discussed.

2. Instantaneous Limited Feedback

These methods utilize pre-designed codebooks to convey information about instantaneous CSI through the feedback channel to adapt signal transmission to the eigenstructure of the channel. They can approach the ideal system performance obtained with full channel knowledge at the transmitter but require feedback for every channel realization. Codebooks are available in current literature for both uncorrelated Rayleigh fading channels and correlated Rayleigh fading channels of the form RH, where H is uncorrelated and R is the spatial correlation matrix. The latter codebooks can be used with the inventive embodiments if the original H is uncorrelated, and by replacing R with the linear whitening filter W.

3. Limited Feedback for Arbitrary Channel Distributions

These algorithms do not assume any channel distributions and base precoding on statistical or instantaneous CSI. They use a bank of codebooks available at the transmitter and receiver to adapt the choice of codebook based on the channel distribution. They outperform uniform codebooks designed for uncorrelated channels when the channel distribution is arbitrary. Such codebooks are directly applicable to the embodiments above that quantize the effective channel.

As can be seen, feedback 320 of CSI for the effective channel will depend on the system involved and may include, for example, sending the actual effective channel matrix H_{eff} via the feedback channel, sending statistics (e.g., mean+variable) of H_{eff}, quantizing H_{eff} and sending indices for codebook reference or any combination of the foregoing techniques. In other embodiments, only the value of V_{eff} (or indices/statistics thereof), might be fed back.

The estimated channel H (or indicia thereof) may additionally be fed back as part of the CSI if desired, for example, to determine subcarrier modulation, although the embodiments are not limited in this respect. In fact, the inventive embodiments are not limited to any specific form or format of CSI feedback so long as some indicia of the effective channel after interference mitigation is available to the precoder of the transmitting device.

The transmitting device receiving the CSI of the effective channel may then select the precoding matrix as a function of the effective channel (after CCI mitigation) as opposed to basing precoding as a function of the estimated channel H. Using the example discussed previously, the precoding matrix F may selected as F=V_{eff} so the channel may be diagonalized by the receiver.

Turning to FIG. 3, a communication system 300 according to various embodiments may include a transmitter 310 and a receiver 360 that communicate via an OFDM MIMO air interface although the embodiments are not limited in this respect. Transmitter 310 and receiver 360 may include elements similar to existing communication devices such as coding/modulation or detection/ demodulation logic 312, 362 and Fast Fourier Transform (FFT)/Inverse FFT logic 314, 364 and/or other components as suitable desired.

In various embodiments of the present invention, however, transmitter 310 may include a precoding circuit 320 that is adapted to precode as a function of the effective channel after CCI mitigation. To this end, precoding circuit 320 of transmitter 310 may include a precoder 322 and channel state information logic 324 so that precoding matrices may be used that correspond to feedback of the effective channel sent by receiver 360 via feedback channel 390.

Receiver 360 may include CCI mitigation logic 368 to mitigate/suppress and/or filter CCI present, for example, from co-channel interferer 114. Receiver 360 may also include channel estimation and feedback logic 370 to estimate the channel, determine the effective channel and feedback indicia of the effective channel as discussed previously. For sake of simplicity, system 300 shows only a transmitter portion of transmitting device 310 and only the receiving portion of receiving device 360. However, in practical application, a communication apparatus would likely have both a transmitter portion and receiving portion similar to those shown in FIG. 3.

In some embodiments the components and protocols of such an apparatus may be configured to be compatible with one or more of the Institute of Electrical and Electronics Engineers (IEEE) 802.11 standards for WLANs and/or 802.16 standards for broadband WMANs, although the embodiments are not limited in this respect.

A communication apparatus utilizing the components shown in FIG. 3 may be, for example, a wireless base station, wireless router, user station and/or network interface card (NIC) or network adaptor for computing or communication devices. Accordingly, the functions and/or specific configurations of a communication apparatus embodying the principles of the inventive embodiments would be included as suitably desired.

The components and features of an apparatus embodying a transmitter and/or receiver similar to those in FIG. 3 may be implemented using any combination of discrete circuitry, application specific integrated circuits (ASICs), logic gates and/or single chip architectures. Further, the features of such an apparatus may be implemented using microcontrollers, programmable logic arrays and/or microprocessors or any combination of the foregoing where suitably appropriate. Thus, as used herein, the terms circuit, component and logic may be used interchangeably and could mean any type of hardware, firmware or software implementation and the inventive embodiments are not limited to any specific implementation.

Embodiments of apparatus according to the present invention may be implemented using MIMO, SIMO or MISO architectures utilizing multiple antennas for transmission and/or reception. Further, embodiments of the invention may utilize multi-carrier code division multiplexing (MC-CDMA) multi-carrier direct sequence code division multiplexing (MC-DS-CDMA) or any other existing or future arising modulation or multiplexing scheme compatible with the features of the inventive embodiments.

Unless contrary to physical possibility, the inventors envision the methods described herein: (i) may be performed in any sequence and/or in any combination; and (ii) the components of respective embodiments may be combined in any manner.

Although there have been described example embodiments of this novel invention, many variations and modifications are possible without departing from the scope of the invention. Accordingly the inventive embodiments are not limited by the specific disclosure above, but rather should be limited only by the scope of the appended claims and their legal equivalents.

The invention claimed is:

1. A method for communicating in a wireless network, the method comprising:
precoding signals in a multiple-input-multiple-output (MIMO) system based on effective channel information fed back from a receiving device, wherein the effective channel information comprises information regarding a communication channel after co-channel interference (CCI) mitigation by the receiving device.

2. The method of claim 1 wherein the effective channel information comprises statistics representing the communication channel characteristics after the CCI mitigation.

3. The method of claim 1 wherein the effective channel information comprises a plurality of indices representing quantization of the effective channel after CCI mitigation.

4. The method of claim 1 wherein the CCI mitigation comprises filtering colored noise detected in the communication channel.

5. The method of claim 1 wherein the CCI mitigation comprises applying whitening filter to a signal received by the receiving device.

6. The method of claim 1 wherein precoding MIMO signals comprises multiplying a data signal by a precoding matrix, the preceding matrix being a function of an effective communication channel after CCI mitigation.

7. The method of claim 1 further comprises modulating the signals using a modulation technique selected from the group consisting of orthogonal frequency division multiplexing (OFDM), orthogonal frequency division multiple access (OFDMA), code division multiple access (CDMA) or single carrier modulation.

8. An apparatus for wireless communications, the apparatus comprising:
a precoder circuit to precode a signal for multi-antenna transmission based on channel state information (CSI) fed back from a receiving device, wherein the precoder circuit uses a precoding matrix that is a function of an effective channel after co-channel interference (CCI) mitigation.

9. The apparatus of claim 8 wherein the CCI mitigation comprises application of a whitening filter by the receiving device.

10. The apparatus of claim 8 wherein the apparatus comprises a multiple-input multiple-output (MIMO) orthogonal frequency division multiplexing (OFDM) communication device.

11. The apparatus of claim 8 further comprising a transmitter to transmit precoded MIMO signals.

12. An apparatus for wireless communication, the apparatus comprising:
a mitigation circuit to mitigate co-channel interference (CCI) of signals received over at least two antennas from a transmitting device; and
a channel state information (CSI) feedback circuit coupled to the mitigation circuit to feedback indicia of an effective channel to the transmitting device, wherein the effective channel represents an impact on an estimated channel with the transmitting device as a result of CCI mitigation.

13. The apparatus of claim 12 wherein the indicia comprise one of statistics representing the effective channel or indices representing a quantization of the effective channel.

14. The apparatus of claim 12 further comprising a demodulator in communication with the mitigation circuit to demodulate received orthogonal frequency division multiplexing (OFDM) signals.

15. The apparatus of claim 12 wherein the apparatus comprises a user station.

16. The apparatus of claim 12 wherein the apparatus comprises a base station.

17. A system for communicating in a wireless network, the system comprising:
a transmitter comprising a precoder circuit to precode signals for multi-antenna transmission based on channel state information (CSI) fed back from a receiving device, wherein the precoder circuit uses a precoding matrix that is a function of an effective channel after co-channel interference (CCI) mitigation by the receiving device; and
at least two antennas coupled to the transmitter to radiate the precoded signals as electromagnetic waves.

18. The system of claim 17 wherein the transmitter further comprises:
an orthogonal frequency division multiplexing (OFDM) modulator circuit coupled to the precoder.

19. The system of claim 17 wherein system comprises one of a user station or a network access station.

20. The system of claim 17 wherein the system further comprises a receiver having its own CCI mitigation circuit and CSI feedback circuit.

21. An article of manufacture having stored thereon machine readable instructions that when executed by a processing platform result in:
applying a co-channel interference (CCI) mitigation algorithm to signals received at a plurality of antennas from a transmitting device; and
feeding back indicia of an effective channel to the transmitting device, wherein the effective channel comprises an estimated channel as impacted by the CCI mitigation algorithm.

22. The article of claim 21 further comprising additional machine readable instructions that when executed by a processing platform result in:
precoding multiple-input multiple-output (MIMO) signals for transmission to a different receiving device using preceding matrices that are a function of a current effective channel as identified from channel state information (CSI) fed back from the different receiving device.
